(19) United States
(12) Patent Application Publication
(10) Pub. No.: US 2021/0019221 A1
(43) Pub. Date: Jan. 21, 2021

(54) RECOVERING LOCAL STORAGE IN COMPUTING SYSTEMS

(71) Applicant: HEWLETT PACKARD ENTERPRISE DEVELOPMENT LP, Houston, TX (US)

(72) Inventor: Muhammad Imran Salim, Houston, TX (US)

(21) Appl. No.: 16/513,019

(22) Filed: Jul. 16, 2019

(51) Int. Cl. G06F 11/07; G06F 3/06

(52) U.S. Cl. CPC G06F 11/0793; G06F 3/0619; G06F 3/0689; G06F 3/067; G06F 3/0655

(57) ABSTRACT

A method for use in a networked computing system, includes: identifying a failure of a first computing device from a management tool, the first computing device including a first network adapter and a first local storage; and directing, from a management tool, the first network adapter to: access a plurality of data stored on the first local storage over an independent connection between the first network adapter and the first local storage; and transmit the data to a second computing device, the second computing device including a second network adapter and a second local storage.

### BACKGROUND

Data centers are computing facilities housing large numbers of computing resources. The computing resources may vary widely in type and composition and may include, for instance, processing resources, storage and management resources as well as a variety of services. The computing resources may be organized into one or more large-scale computing systems. Common types of large-scale computing systems include, without limitation, enterprise computing systems and clouds, for instance. More precisely, clouds are groupings of various kinds of resources that are typically implemented on large scales.

Data centers, in particular, and large-scale computing systems, in general, contain many thousands of different kinds of computing resources. To ease the burden of administering all these computing resources, the computing arts have turned to automated, software-implemented, tools to help manage operations. One such software-implemented tools is a “management tool”. A management tool performs a number of duties such as maintaining a directory of all the network devices in a network, storing information (or “profiles”) for the devices in the directory, and monitoring the operations of the network devices for health and failure.

### BRIEF DESCRIPTION OF THE DRAWINGS

The invention may be understood by reference to the following description taken in conjunction with the accompanying drawings, in which like reference numerals identify like elements.

FIG. 1 conceptually illustrates a data center housing a computing system in accordance with one or more examples of the subject matter claimed below.

FIG. 2 schematically illustrates selected portions of the hardware and software architecture of one particular example of a computing device such as may be used to implement the computing devices in FIG. 1 employing an independent connection in one example of that which is claimed below.

FIG. 3 schematically illustrates selected portions of the hardware and software architectures of the local storage of the computing device of FIG. 2 in one or more examples.

FIG. 4 schematically illustrates selected portions of the hardware and software architectures of the network adapter of the computing device of FIG. 2 in one or more examples.

FIG. 5 shows a particular example by which the independent connection first shown in FIG. 2 may be implemented.

FIG. 6 illustrates a portion of the computing system first shown in FIG. 1.

FIG. 7 illustrates a method practiced in accordance with one or more examples.

FIG. 8 illustrates a method practiced in accordance with one or more examples.

FIG. 9 conceptually illustrates a data center housing a computing system in accordance with one or more examples of the subject matter claimed below.

FIG. 10 illustrates selected portions of a hardware and software architecture of an administrative console as may be used in one or more examples.

While the invention is susceptible to various modifications and alternative forms, the drawings illustrate specific embodiments herein described in detail by way of example. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION

Illustrative examples of the subject matter claimed below will now be disclosed. In the interest of clarity, not all features of an actual implementation are described in this specification. It will be appreciated that in the development of any such actual implementation, numerous implementation-specific decisions may be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

Among the many advantages of large-scale computing systems is that, when a computing resource fails, there typically are other computing resources available to which the failing computing resource's responsibilities may be shifted. So, when a computing resource fails, the processing load can be shifted to another processing resource. And when a storage resource fails, the data it is storing may be shifted to another storage resource. This ability to shift, substitute, and otherwise manage computing resources may help maintain productivity and performance. Thus, when a computing resource fails, actions may be taken to address the failure.

These types of actions addressing a failure typically begin with recovery from the failure. If the failed computing resource is a computing device, it may include a processing resource, memory, local storage, and a network adapter. The processing resource will typically be hosted on a motherboard and execute tasks associated with the assigned functionality of the computing device. The local storage is connected to the motherboard. The processor may use the local storage in the execution of tasks and for storing data associated with those tasks.

A part of failure recovery for such a computing device may include recovery of the data in the local storage. However, data recovery in a faded computing device may be hampered by the failed components. For example, processes running on the computing device may store data to a local storage. Should the motherboard itself fail, the local storage may not be able to communicate with other components of the computing device, thereby inhibiting recovery of the data stored therein. Similarly, if a storage controller connected to the motherboard fails, access to local storage via that storage controller is not possible.

The present disclosure includes techniques for recovering data volumes from server or other computing device hardware whose major components have failed to a point where only few and minimal hardware components remain functional. These techniques may allow remote recovery of data volumes from local storage of devices in a cloud supporting infrastructure or data center. Specifically, disclosed techniques may allow recovery of data without requiring physical movement of hard drives from failed systems. To support these techniques, server hardware may be designed to provide an additional independent communication path between a network adapter and a local storage connector. Local storage connectors may be implemented based on different interfaces to storage devices. Example interfaces include Small Computer Systems Interface (“SCSI”), Serial Attached SCSI (“SAS”), and Serial Advanced Technology Attachment (“serial ATA”, “SATA” or “S-ATA”) or other similar storage device protocol. In other words, this disclosure represents an improvement to the functioning of computer systems, in part, by providing and utilizing an independent independent connection between a network adapter and a local storage connector.

In case of major failure of server hardware components, disclosed techniques allow for data to be recovered from local storage as long as the network adapter is able to receive power from a power supply and the local storage remains accessible, i.e., not crashed. To facilitate data recovery, the network adapter as disclosed herein would directly access the local storage via the above referenced independent connection. Further, because the network adapter is likely already connected to an outside network, the network adapter can start transmitting data read from the local storage to another external entity, for instance, through a networking switch (e.g., on the outside network).

To provide availability to recovered data, the external entity may be selected from a profile maintained by a management tool. For example, the profile may be used to identify another server or some other computing device with similar capabilities as defined in a profile maintained by a management tool. In practice, the external computing device receives the data, copies the received data to its local storage, and makes the received data available. In some cases, this may include booting the external computing device (e.g., if the recovering device was not already active in the environment).

The management tool searches for equivalent or better hardware and then orchestrate and coordinate the data transmit. After the transmit is complete to the second computing device, the management tool reconfigures the second computing device based on the profile of the previously failed computing device. For example, reconfiguration may include: updates to network connections, re-programming of Media Access Control (“MAC”) and World Wide Port Name (“WWPN”) addresses, configuration of Basic Input/Output System (“BIOS”) for storage volumes, and boot configurations, etc.

This disclosure therefore provides for systems having an independent connection between the local storage and a network adapter. The network adapter may be programmed (e.g., via software or firmware) to perform disclosed techniques of data recovery. For example, upon direction from a management tool upon detecting a failure condition in the computing device, the disclosed network adapter may retrieve data from the local storage over the independent connection and transmit the retrieved data to another location. In some examples, the “another location” may be another computing device whose network adapter has been modified (e.g., with the disclosed independent access) to receive the transmitted data from the first network adapter and write it to its local storage.

In one particular example, a method for use in a networked computing system, includes: identifying a failure of a first computing device from a management tool, the first computing device including a first network adapter and a first local storage; and directing, from a management tool, the first network adapter to: access a plurality of data stored on the first local storage over an independent connection between the first network adapter and the first local storage; and transmit the data to a second computing device, the second computing device including a second network adapter and a second local storage.

In another example, a computing device, includes: a local storage; and a network adapter to which the local storage is indirectly electronically connected for routine operations and independently connected for failure recovery. The network adapter is programmed to: access data from the local storage over the independent connection responsive to an external direction upon a detected failure in the computing device; and transmit the retrieved data to another location.

In still another example, a computing device, includes: a local storage; a network adapter; and an independent connection over which the network adapter accesses data from the local storage upon the external direction. The network adapter programmed to: access data from the local storage responsive to an external direction responsive to detected failure in the computing device; and transmit the retrieved data to another location; and

In yet another example, a networked computing system, includes: a network connection; a first computing device, and a second computing device. The first computing device includes: a first local storage; and a first network adapter to which the first local storage is indirectly electronically connected for routine operations and independently connected for failure recovery. The first network adapter is programmed to: access data from the first local storage over the independent connection responsive to an external direction responsive to detected failure in the computing device; and transmitting the retrieved data to another location over the network connection. The second computing device includes: a second local storage; and a second network adapter. The second network adapter is programmed to: receive the data transmitted by the first network adapter over the network connection; and store the received data in the second local storage.

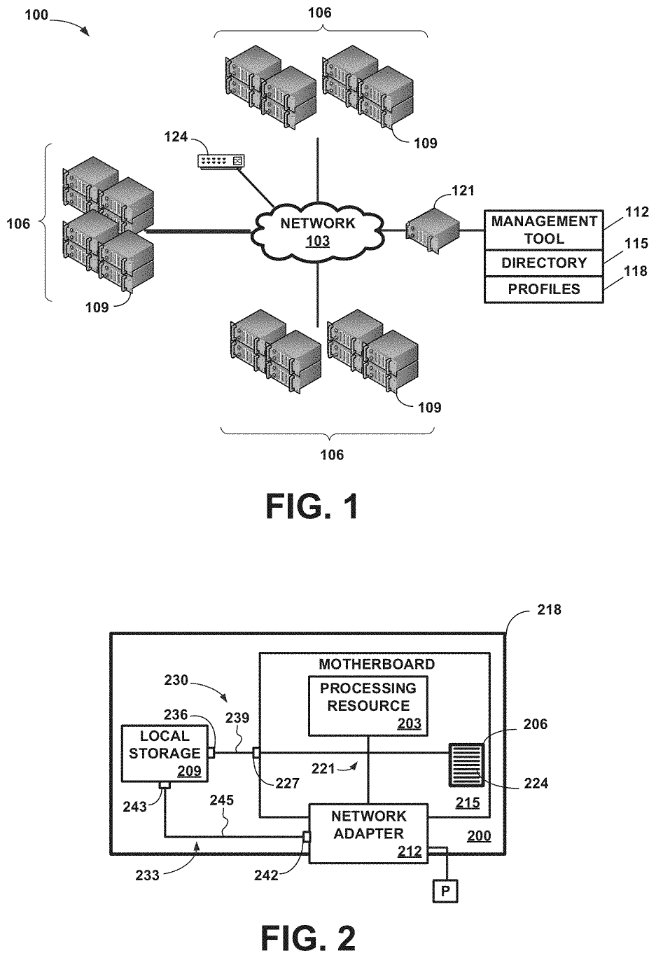

FIG. 1 illustrates an example data center 100 housing a computing system in accordance with one or more examples of the subject matter claimed below. The data center 100 includes a networked computing system 103. Those in the art having the benefit of this disclosure will appreciate that the data center 100 will also include supporting components like backup equipment, fire suppression facilities, and air conditioning that are not shown. These details are omitted for the sake of clarity and so as not to obscure that which is claimed below.

A data center network such as the networked computing system 103 typically includes a networking infrastructure including computing resources, e.g., core switches, firewalls, load balancers, routers, distribution and access switches, servers, etc., along with any hardware and software required to operate the same, For present purposes, the networked computing system 103 will be described as clusters 106 of computing resources, each including at least one computing device 109. Note that only one computing device 109 is indicated in each of the clusters 106. The computing system 103 also includes one or more networking switches 124 through which network traffic flows. Again, those in the art will appreciate that any given implementation of the networked computing system 103 may be more detailed. However, these details are omitted for the sake of clarity and so as not to obscure that which is claimed below.

The networked computing system 103 includes a management tool 112. The management tool 112 automates many of the functions in managing the operation and maintenance of the networked computing system 103. For instance, the management tool 112 may provision new computing devices 109 as they are added to the computing system 103. The management tool 112 maintains a directory 115 of the computing devices 109 and profiles 118 for each of the computing devices 109.

FIG. 2 schematically illustrates one particular example of a computing device 200 that may be used to implement the computing devices 109 in FIG. 1. The computing device 200 includes a processing resource 203, a memory 206, a local storage 209, and a network adapter 212. In the present context, “local storage” means Direct Attached Storage (DAS) to server using traditional Small Computer Systems Interface (“SCSI”), Serial Attached SCSI (“SAS”), and Serial Advanced Technology Attachment (“serial ATA”, “SATA” or “S-ATA”) or similar direct attached storage device protocols. The processing resource 203 is hosted on a motherboard 215 for the computing device 200. Note that the local storage 209 is directly, electronically connected to the processing resource 203 on the motherboard 215 and is in the same enclosure 218 as the processing resource 203.

The processing resource 203 may be any processing resource suitable for the function assigned the computing device 200 within the context of the networked computing system 103. The processing resource 203 may be a microprocessor, a set of processors, a chip set, a controller, etc. The memory 206 also resides on the motherboard 215 with the processing resource 203. The memory 206 is implemented in a non-transitory computer-readable medium (not separately shown). At least a portion of the memory 206 is nonvolatile (or, “persistent”) read-only memory encoded with firmware 224. The firmware 224 may include, for instance, the basic input/output system (“BIOS”), etc. Execution of the firmware 224 by the processing resource 203 imparts the functionality of the processing resource 203 described herein to the processing resource 203. The motherboard 215 includes a connector 227 by which the processing resource 203 may communicate with the local storage 209 as discussed further. The processing resource 203 communicates with the memory 206, and network adapter 212 over a bus system 221.

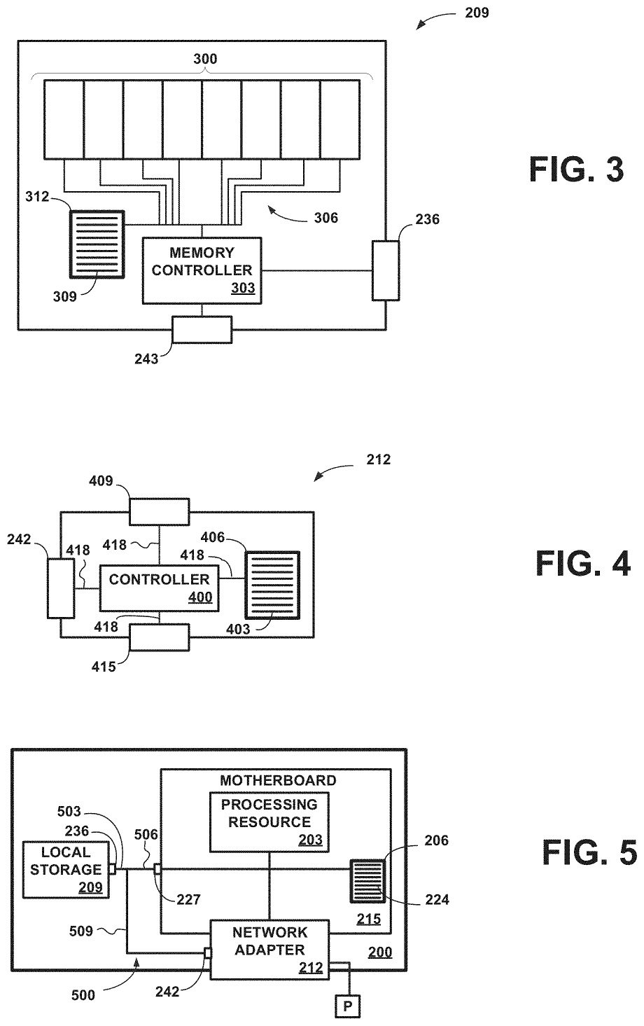

The local storage 209, while located in the same enclosure 218, is separate from the motherboard 215. As shown in FIG. 3, the local storage 209 includes a plurality of storage media 300. The storage media 300 may be any suitable storage media known to the art—for instance, hard disk drives, solid-state drives, or some combination of the two. The local storage 209 also includes a memory controller 303, which may be considered a kind of processing resource. The memory controller 303 operates in accordance with instructions from firmware 309 stored in a memory 312. Execution of the firmware 309 imparts the functionality of the memory controller 303 described herein to the memory controller 303. The memory 312 is implemented in a non-transitory computer-readable medium (not separately shown). At least a portion of the memory 312 is nonvolatile (or, “persistent”) read-only memory encoded with the firmware 309. The memory controller 303 communicates with the storage media 300 and the memory 312 over a bus system 306.

Referring collectively to FIG. 3 and FIG. 2, the local storage 209 further includes a connector 236 for communication to motherboard 215 and an independent connector 243 through which the memory controller 303 communicates with the processing resource 203 and the network adapter 212, respectively, in a manner described more fully below. The memory controller 303 also communicates with the connector 236 and the independent connector 243 over the bus system 306.

The network adapter 212, shown in FIG. 2, may be integrated with the motherboard 215 or, as shown, be a separate component of the computing device 200. As shown in FIG. 4, the network adapter 212 also includes a controller 400 that loads and executes firmware 403 from a memory 406. The memory 406 is implemented in a non-transitory computer-readable medium (not separately shown). At least a portion of the memory 406 is nonvolatile (or, “persistent”) read-only memory encoded with the firmware 403. Execution of the firmware by the controller 400 imparts the functionality of the network adapter 212, including that functionality which is claimed below.

Referring now collectively to FIG. 4 and FIG. 2, the controller 400 of network adapter 212 includes a connector 409 by which the controller 400 communicates with the processing resource 203 and an independent connector 242 by which the controller 400 communicates with the local storage 209. The network adapter 212 also includes a network connector 415 by which the controller 400, and the computing device as a whole, communicates externally (e.g., with the networked computing system 103 as shown in FIG. 1). The controller 400 communicates with the memory 406, the connector 409, the independent connector 242, and the network connector 415 over a bus system 418.

Referring collectively to FIG. 2-FIG. 4, bus system 221, bus system 306, and bus system 418 may be implemented using any suitable bus protocol. Popular bus protocols that may be used include, for instance, Peripheral Component Interconnect Bus (“PCI bus”), Industry Standard Architecture (“ISA”), Universal Serial Bus (“USB”), FireWire, and Small Computer Systems Interface (“SCSI”). This list is neither exhaustive or exclusive. The selection of the one or more bus protocols will depend to some degree on the type of communication being held in a manner well known to the art.

Notably, the processing resource 203 will typically communicate with the local storage 209 via the bus system 221 using a direct attached storage device protocol intended for that purpose. Examples of such protocols are Small Computer Systems Interface (“SCSI”), Serial Attached SCSI (“SAS”), and Serial Advanced Technology Attachment (“serial ATA”, “SATA” or “S-ATA”). Again, this list is neither exhaustive nor exclusive and still other suitable protocols may be used.

SCSI, for instance, defines a standard interface for connecting peripheral devices to a personal computer, however SCSI is also used to interface powerful computing devices such Redundant Arrays of Independent Disks (“RAIDs”), servers, storage area networks, etc. SCSI uses a controller to transmit data between the devices and the SCSI bus. The controller is usually either integrated on the motherboard—e.g., the motherboard 215 in FIG. 2—or a host adapter is inserted into an expansion slot on the motherboard. The SCSI controller, for instance, provides software to access and control devices—e.g., the local storage 209.

SAS is a serial transmission (as opposed to parallel transmission as in SCSI) protocol that is frequently used with storage systems. SAS is a point-to-point architecture where each device has a dedicated connection to the initiator. That is, SAS is a point-to-point serial peripheral interface in which controllers are connected directly to local storage, such as disk drives. SAS permits multiple devices of different sizes and types to be connected simultaneously. For instance, SAS devices can communicate with both SATA and SCSI devices. Unlike SCSI devices, SAS devices include two data ports, or connectors.

SATA is a bus interface that may be used for connecting host bus adapters with mass storage devices. Mass storage devices may include optical drives or hard drives. Examples of mass storage devices include, for instance, optical drives, hard disk drives, solid-state drives, external hard drives, RAID and USB storage devices. This list is neither exhaustive nor exclusive. SATA is commonly used to connect hard disk drives—e.g., the local storage 209 in FIG. 2—to a host system including a computer motherboard—e.g., the motherboard 215 in FIG. 2.

The term “local storage”, as used herein, means direct attached storage to a server using traditional SAS, SATA, SCSI or some similar direct attached storage device protocol. “Direct attached storage” describes storage devices or peripherals directly connected to the motherboard within the same enclosure that is accessible to its hosting computer device without communicating over a networked connection. The local storage may include any suitable kind of storage devices such as hard disk drives and solid-state drives. It may also include less traditional kinds of storage devices such as tape drive, optical disks, floppy disks, etc., that are now less common due to changes in technology.

Returning to FIG. 2, the network adapter 212 provides the network connection by which the computing device 200 interacts with the rest of the networked computing system 103, shown in FIG. 1. The network adapter 212 supports multiple network protocols including, without limitation, protocols such as Ethernet. Note that, in some examples, the network adapter 212 may be implemented in a Network Interface Card (“NIC”) modified in its firmware to emulate a network adapter, including supporting multiple networking protocols.

Those of ordinary skill in the art having the benefit of this disclosure will appreciate that in a computing device 109, shown in FIG. 1, a network adapter will frequently receive its power through the motherboard. The network adapter 212 of the network device 200 in FIG. 2 receives power from a source P that is independent of the rest of the network device 200. Thus, if the failure of the network device 200 affects the ability to deliver power to the network adapter 212, the network adapter 212 will continue to receive power so that it can function in accordance with the disclosure herein.

The network adapter 212 is electronically connected to the local storage 209 by an primary connection 230 and an independent connection 233. The primary connection 230 includes portions of the bus system 221 by which network adapter 212 communicates with the processing resource 203 and by which the processing resource 203 communicates with the local storage 209. It also includes the connectors 236, 227 and the cable 239 that connect the bus system 221 to the local storage 209. The independent connection 233 includes the connectors 242, 243 and the cable 245.

The independent connection 233 is, in the illustrated example, a direct redundant connection and the primary connection 230 is an indirect connection. As used in this disclosure, the term “direct connection” means that there are no intermediate electronic components between the network adapter 212 and the local storage 209. The term “indirect connection” means that there are intermediate electronic components between the network adapter 212 and the local storage 209. Thus, the primary connection 230 is indirect because communications between the network adapter 212 its communications with the local storage 209 are routed indirectly through the processing resource 203 and the motherboard 215. Similarly, the direct redundant, independent connection 233 is “direct” because there are no electronic components between the network adapter 212 and the local storage 209. Communications between the network adapter 212 and the local storage 209 are therefore routed directly therebetween.

The independent connection 233 is “independent” of other access mechanisms relative to the local storage 209, including the primary connection 230. Thus, in the event of failure somewhere that prevents access to the local storage 209 over, for instance, the primary connection 230, the independent connection 233 will still be available for local storage recovery. Where the independent connection 233 is direct, there are no electronic components to fail. This helps ensure that the independent connection 233 is available when needed and is less likely to experience failure itself. However, the independent connection 233 need not be a direct connection in all examples.

The primary connection 230 is “primary” because it is the connection used in routine operations of the computing device for communications with the local storage 209. These communications are primarily with the processing resource 203 in the execution of tasks associated with the functionality of the computing device 200 in the networked computing system 103, shown in FIG. 1. The independent connection 233 is, in the illustrated example, “redundant” because it is used during failure recovery instead of the primary connection 230 if one or more electronic components of the computing device 200 should fail. Since the independent connection 233 is “direct”, electronic component failures will not interrupt data transmit in failure recovery.

The subject matter claimed below admits variation in the manner in which the independent connection 233 may be implemented. As shown in FIG. 2, the network adapter 212 and the local storage 209 may be equipped with the connectors 242, 243. The connectors 242, 243 are independent connectors in the same sense that the independent connection 233 is “redundant”—they are not used in routine operations, but only in failure recovery operations.

FIG. 5 shows an alternative example in which the independent connection 500 includes an independent connector 242 of the network adapter 212, a split cable 503, and the primary connector 236 of the local storage 209. One end of the split cable 503 is connected to the primary connector 236 of the local storage 209. The other end of split cable 503 has one branch 506 of the split cable 503 connected to the connector 227 of the motherboard 215 and one branch 509 connected to the independent connector 242 of the network adapter 212. Those of ordinary skill in the art having the benefit of this disclosure may appreciate still further variations within the scope of that which is claimed below.

Returning now to FIG. 1, the management tool 112 is shown residing on a computing device 121 at any given time. However, those in the art having the benefit of this disclosure will appreciate that the management tool 112 may be distributed across one or more computing devices, including the computing devices 109, in some examples. The management tool 112, as discussed above, performs a number of management functions. Among these functions is maintenance of a directory 115 of profiles 118 for the computing devices 109 that are a part of the networked computing system 103. Only one of the profiles 118 is indicated in FIG. 1.

More particularly, each computing device 109 is associated with one or more profiles 118, only one of which may be active for each computing device 109. The profiles 118 include, for each computing device 109, a wide array of identifying and operational information. This information may include, for instance, the serial number, make, model, configuration, settings, network addresses, and operational characteristics such as CPU speed, number of CPU cores, memory size, disk space, etc. for each of the computing devices 109. In some examples, the directory 115 and profiles 118 may be merged so that the directory 115 includes the profiles 118 or the profiles 118 may serve as the directory 115. There are several management tool tools, sometimes called “appliances”, that are commercially available and suitable for modification to implement the claimed subject matter as described herein.

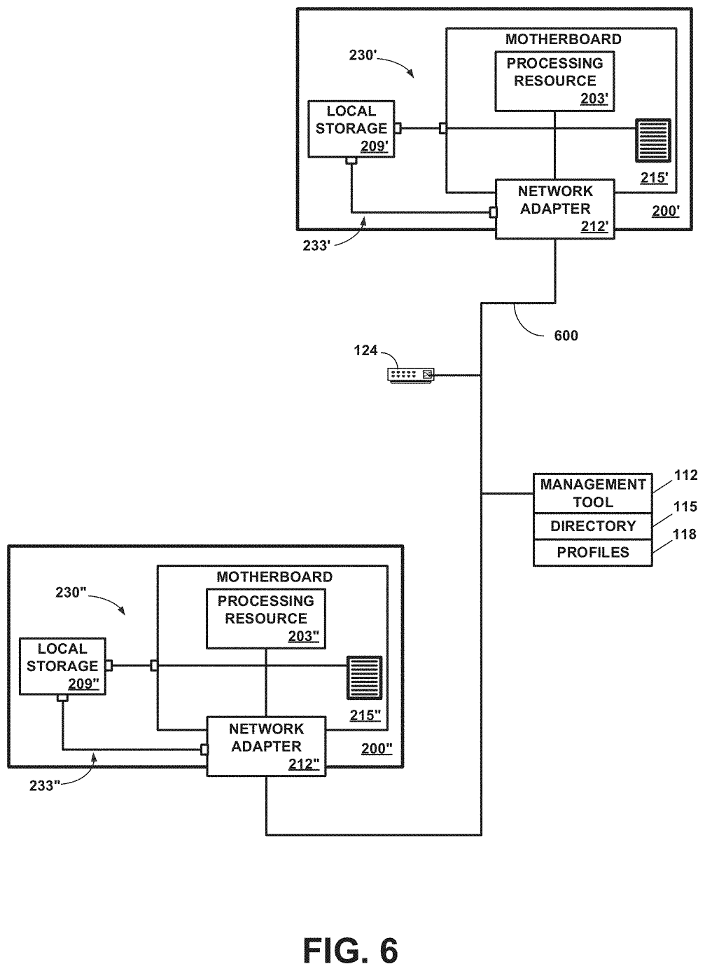

FIG. 6 illustrates a portion of the networked computing system 103 first shown in FIG. 1. The portion includes two computing devices 200′, 200″ and the management tool 112 all connected over the network connection 600. The computing device 200′ includes a network adapter 212′, a motherboard 215′, and a local storage 209′. The network adapter 212′ is connected to the local storage 209′ by an primary connection 230′ and an independent connection 233′, all as described above. The computing device 200″ includes a network adapter 212″, a motherboard 215″, and a local storage 209″. The network adapter 212″ is connected to the local storage 209″ by an primary connection 230″ and an independent connection 233″, all as described above.

Referring collectively to FIG. 1 and FIG. 6, the management tool 112 monitors the operation of the computing devices 200′, 200″ over the network connection 600, as well as other computing devices 109 shown in FIG. 1, of the networked computing system 103. The management tool 112 builds and maintains the directory 115 as new computing devices 109 are added and removed from the networked computing system 103. Profiles 118 for the computing devices 109 are maintained by the management tool 112, including profiles for the computing devices 200′, 200″.

In this particular example, the computing device 200′ fails and, more particularly, the motherboard 215′ fails. The failure of the motherboard 215′ renders the primary connection 230′ inoperable such that the local storage 209′ cannot be reached therethrough. The management tool 112 will then become aware of the failure. The manner in which this happens depends on the implementation of the management tool 112 and the networked computing system 103 in general. In some examples, the management tool 112 may become aware through its own efforts or it may be notified by, for instance, the network adapter 212′. Either way, the monitoring by the management tool 112 determines that the computing device 200′ has failed.

The management tool 112 then searches the profiles 118 for the computing devices 109 in the directory 115 for a substitute or destination computing device 109. That is, the management tool 112 searches for a computing device 109 that will be replace the computing device 200′ or to which the operations of the computing device 200′ may be shifted. In the illustrated example, the management tool 112 searches the profiles 109 for a computing device 109 of the same make and model as the failed computing device 200′. Other examples, however, may use other criteria for determining what constitutes an acceptable replacement or destination.

In the example of FIG. 6, the management tool 112 identifies the computing device 200 as an acceptable destination for at least data recovered from the local storage 209′ of the failed computing device 200′. The management tool 112 knows the network address for the both the failed computing device 200′ and the destination computing device 200″. This is typically information stored in the profiles 118 for each of the computing devices 200′.

The management tool 112 then sends a directive to the network adapter 212′ to transmit the data stranded on the local storage 209′ by the failure of the motherboard 215′ to the destination computing device 200″. This directive is “external” to the network adapter 212′ in the sense that it originates from outside the computing device 215′. In this particular example, the directive originates with the management tool 112, but some embodiments may originate elsewhere within the networked computing system 103.

The firmware (not shown) of the network adapter 212′ has been modified to execute the external directive upon its receipt. The particular direct attached storage device protocol used by the local storage 209′ is known to the network adapter 212′ so that the network adapter 212′ communicate with the local storage 209′. The network adapter 212′ then, responsive to the external directive, accesses data stranded in the local storage 209′. In this example data is stranded by the failure of the motherboard 215′ and, hence, is no longer available via the primary connection 230′. Accordingly, the network adapter 212′ accesses stranded data over the independent connection 233′. Note that the absence of electronic components in the independent connection 233′ reduces the likelihood that a failure affecting the primary connection 230′ will also affect the independent connection 233′.

Upon accessing the stranded data from the local storage 109′ over the independent connection 233′, the network adapter 212′ transmits the retrieved data to another location via the networking switch 124. That location is specified in the external directive provided by the management tool 112 as the network address of the computing device 109 that the management tool 112 has selected from the profiles 118. The network adapter 212′ then transmits the previously stranded data to the destination over the network connection 600 using the appropriate protocol appropriate for the network connection 600.

Thus, in this particular example, the faded computing device 200′ includes the local storage 209′ the network adapter 212′, and an independent connection 233′. The network adapter 212′ is programmed to: access data from the local storage 209′ responsive to an external direction responsive to detected failure in the computing device 200′ and transmit the retrieved data to another location. The network adapter 212′ accesses and transmits the data from the local storage 209′ using the independent connection 233′ responsive to the external direction.

In this particular example, the destination selected by the management tool 112 is the destination computing device 200″. As discussed above, the destination computing device 200″ is selected because it is the same make and model as the failed computing device 200′. The selected computing device therefore has the same software and hardware architecture as the failed computing device 200′. The destination computing device 200″ also has the same operational characteristics as the failed computing device 200′ for that same reason.

Note that this is not necessary for the practice of that which is claimed below. The software and hardware architectures of the destination computing device 200″ may vary from that of the failed computing device 200′ in some examples. Similarly, the operational characteristics of the destination computing device 200″ may vary from those of the failed computing device 200′ in some respects in some examples. The destination computing device 200″ may represent a computing device capable of providing access, to otherwise stranded data, so that devices connected to network 600 may have access to the data.

The destination computing device 200″ includes a second network adapter 212″. The second network adapter 212″ is programmed to: receive the data transmitted by the first network adapter over the network connection; and store the received data in the local storage. When the network adapter 212″ of the destination computing device 200″ receives the transmitted data, it stores the received data in the local storage 209″ over the independent connection 233″. The management tool 112 then changes settings and configurations across the networked computing system to reflect the change in location of the recovered data.

Note that, as was discussed above, the destination computing device 200″ has the same hardware and software architecture as the failed computing device 200′ in this particular example. Thus, the failed computing device 200″ also includes the local storage 209″ the network adapter 212″, and an independent connection 233″. The network adapter 212″ is programmed to: access data from the local storage 209″ responsive to an external direction responsive to detected failure in the computing device 200″ and transmit the retrieved data to another location. The network adapter 212″ accesses and transmits the data from the local storage 209″ over the independent connection 233″ responsive to the external direction.

Accordingly, should the role of the computing devices 200′, 200″ be reversed, stranded local data in the failed computing device 200″ may be recovered and transmitted to the computing destination computing device 200′ as described above. The role of the management tool 112 in this example remains the same other than it is the computing device 200″ whose failure is detected and whose network adapter 212″ is externally directed to transmit the stranded data. Note also that it is not necessary in some examples for all computing devices in the networked computing system to implement this local data recovery technique. Similarly, in some examples, a computing device may be only be capable of one or the other of the roles performed in the example of FIG. 6.

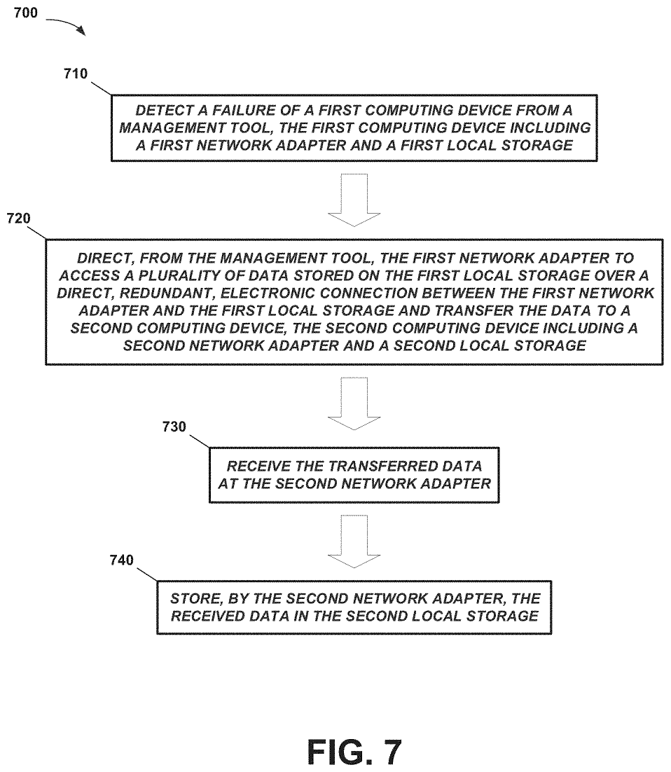

Thus, in accordance with some examples, a method 700 for use in a networked computing system is illustrated in FIG. 7. The method begins by detecting (at 710) a failure of a first computing device from a management tool, the first computing device including a first network adapter and a first local storage. The method 700 then directs (at 720), from the management tool, the first network adapter to access a plurality of data stored on the first local storage over an independent connection between the first network adapter and the first local storage and transmit the data to a second computing device, the second computing device including a second network adapter and a second local storage. Then, the transmitted data is received (at 730) at the second network adapter. Then, the second network adapter stores (at 740) the received data in the second local storage.

The presently disclosed local storage recovery technique admits variation in assorted aspects of what is discussed above. For example, the management tool 112 in the discussion above utilizes what might be termed “rigid profiles”—i.e., the profiles 118. These profiles are “rigid” in the sense that they permit matching only by the make and model of the associated computing device. Thus, a failed computing device is only replaced by an identical computing device, assuming one is available.

Some examples, however, may employ what may be called “flex profiles”. These profiles are “flexible” relative to the “rigid” profiles discussed above because they provide more flexibility in identifying a replacement computing device. More technically, using flex profiles, a computing infrastructure—such as one for the networked computing system 103—is ‘defined’ based upon device attributes, capabilities, and performance characteristics and is ‘agnostic’ of make and model information of computing devices. Thus, matching profiles is not performed on make and model identification, but rather hardware definitions including hardware characteristics such as device attributes, capabilities and performance numbers.

These hardware ‘definitions’ are captured into data structures—i.e., flex profiles. In some examples, flex profiles may strictly exclude make and model definition in order to preserve a robustness provided by matching based on a hardware definition instead. This prevents locking infrastructure into certain models and makes, which would make it easy to interchangeably use hardware from different makes and different models, as long as it has similar or better capabilities and performance metrics. However, in some examples, a flex profile may further include make and model information to permit profile matching on that basis should that be desirable in some context even though this will cancel the robustness afforded by searching based on hardware characteristics.

Accordingly, flex profiles capture most relevant (but not necessarily all) device characteristics and performance attributes. Below is an example of a flex profile:

```
flex profile:
  Name: Example Profile
  Server:
    Speed: 3GHz
      [Value: 300,000,000, Type: long, Unit: Hz]
    Cores:
      [Value: 4, Type: int, Unit: Qty]
    Memory: 64GB
      [Value: 6,400,000,000, Type: long, Unit: B]
    Adapter:
      Speed: 40 Gbps Ethernet
        [Value: 4,000,000,000, Type: long, Unit: bps, Protocol:
        Ethernet]
      CNA: Y
        [Value: Y, Type: boolean]
        [Flex Channels: Value: 8, Type: int]
      Latency: 1 microsecond
        [Value: 1/1,000,000, Type: int, Unit: second]
    Storage:
      Capacity: 5TB
        [Value: 5,000,000,000,000, Type: long, Unit: B]
      Mean Access Time: 1 millisecond
        [Value: 1/1,000, Type: int Unit: second]
      Wear:
        [Value: 300,000, Type: int, Unit: Program/Erase Cycles]
    Networking:
      Speed: 40Gbps
        [Value: 4,000,000,000, Type: long, Unit: bps]
      Latency: 5 microsecond
        [Value: 5/1,000;000; Type: int, Unit: second]
      Ports: 16
        [Value: 16, Type: int, Unit: Qty]
    Connections:
      Connection 1: [Mezz: 3, Port 5, WWPN: 50:0a:09:81:96:97:c3:ac]
      Connection 2: [Mezz: 1, Port 1, MAC: 00:A0:C9:14:C8:29]
```

The flex profile presented above is but one example of the content and structure of a flex profile in accordance with this disclosure. Those in the art having the benefit of this disclosure will appreciate that what constitutes “pertinent information” will vary to some degree by the functionality the computing device. The manner in which this variation occurs and how the above example may be adapted to accommodate it will become apparent to those skilled in the art once they have the benefit of this disclosure.

Identifying a “match” in a flex profile involves a comparison of attributes between the profile of the computing device being replace and the flex profile of an unused device. Some attributes might be complex and it might not be as apparent how to compare them as may be true for other attributes. One example is sequential and random access for flash memory, magnetic hard disk and tape drives. These devices can alternatively be compared with mean access time. A second example is tape storage. Even though tape has fast read and write speeds but extremely large mean access time due to being sequential device, it makes sense to use mean access times as a comparison parameter and not sequential/random access characteristics. Another example is compact flash and hard disk, both have fast read and write speeds but flash has more limited number of writes (reprogram) cycles. Here, it makes sense to compare read and write and not the device type itself. Similar approaches may be taken with other attributes that are complex to compare.

When comparing attributes, in some cases, low numbers are better parameters while in some situations large number indicate higher performance. For instance, for characteristics such as mean access time or latency, lower numbers are generally desirable whereas for characteristics such as read and write speeds, higher numbers generally are preferred. Metadata may be used in the flex profile to indicate the direction of better performance for a given attribute. For instance, in some examples, a plus (“+”) may indicate a higher number is better and a minus (“−”) may indicate a lower number is better. Other examples may use other kinds of metadata for this purpose.

Consider, for instance, the characteristic “latency”, for which one might use the −ve direction. The following pseudo-code excerpt might be used to determine a match, or a preferred match, in a given example:
Latency*Direction
   =>5 ms*−1>10 ms*−1
   =>−5>−10 Therefore,
   −5 is better choice than −10 because it is greater

Or, consider the characteristic “throughput”, for which one might use the +ve direction. The following pseudo-code excerpt might be used to determine a match, or a preferred match, in a given example:
Throughput*Direction
   =>5 mbps*+1>2 mbps*+1
   =>5 mbps>2 mbps
   =>5 mbps is better because it is greater

There may be contexts in which even though there is a “match”, implementing the migration from the computing device being replaced to the prospective computing device is undesirable. This may be, for instance, because transition to the prospective computing device may represent a regression to outdated or obsolete technology. Or there may be other reasons why the transition might be undesirable. For instance, it might be desirable to move from flash memory to hard disk but not necessarily the reverse without further intervention as it might be risky due to limited number of write cycles that flash can endure. Just because a match has been identified and a transition can occur does not necessarily mean that it should.

Accordingly, some examples may subject a profile match to a transition desirability test. Such a test may be conducted through the application of a number of transition rules defining which hardware transitions are desirable, and therefore allowed, and those that are not, and therefor are restricted. These rules might be implemented using something like the following pseudo-code:
Hardware a->Hardware b [allowed]
Hardware a->Hardware c [restricted].

In addition to a match and a desirable transition, the prospective computing device should be evaluated for compatibility. When physically replacing failed hardware or upgrading to new hardware, that new hardware should not only possess a superset of capabilities of previous hardware and equivalent or higher performance but the new hardware should also have been properly tested and verified to work with existing hardware. Most hardware vendors already test other hardware with which theirs might be used for compatibility. Lists therefore exist of compatible hardware and incompatibility hardware. In at least one implementation of management tool this information is kept in what is called a “compatibility matrix”. However, any suitable data structure may be used.

Furthermore, in some transitions the new hardware of the prospective network device will use drivers that are different from those being used by the hardware being replaced. Current drivers will therefore need to be replaced for new drivers or, at the very least, an evaluation must be conducted to see if new drivers should be installed. This may be performed in a routine fashion by, for instance, a management tool using the hardware description in the “matched” flex profile.

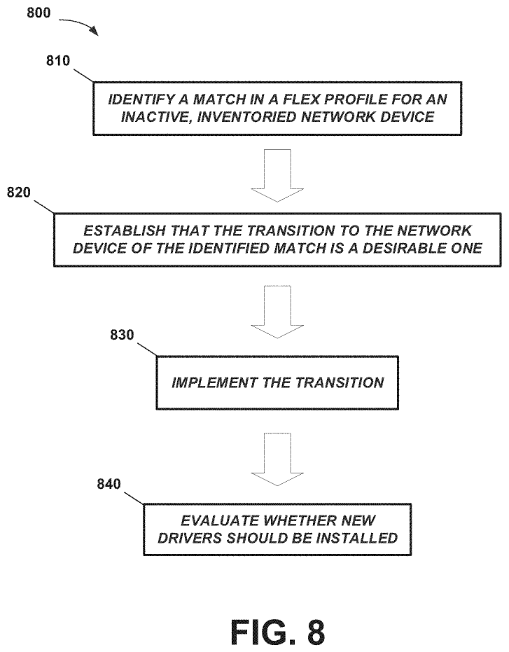

Accordingly, in the examples illustrated herein, whenever a network device is to be replaced for failure, obsolescence, maintenance or repair, or when a network device is being allocated to a cloud or other computing system, a management tool may use the method 800 in FIG. 8. The method 800 begins by identifying (at 810) a match in a flex profile for an inactive, inventoried network device. Next, the method 800 establishes (at 820) that the transition to the network device of the identified match is a desirable one. If the identified match represents a desirable transition, the transition is implemented (at 830). Once the transition is implemented, the drivers are evaluated (at 840) to see if new drivers should be installed.

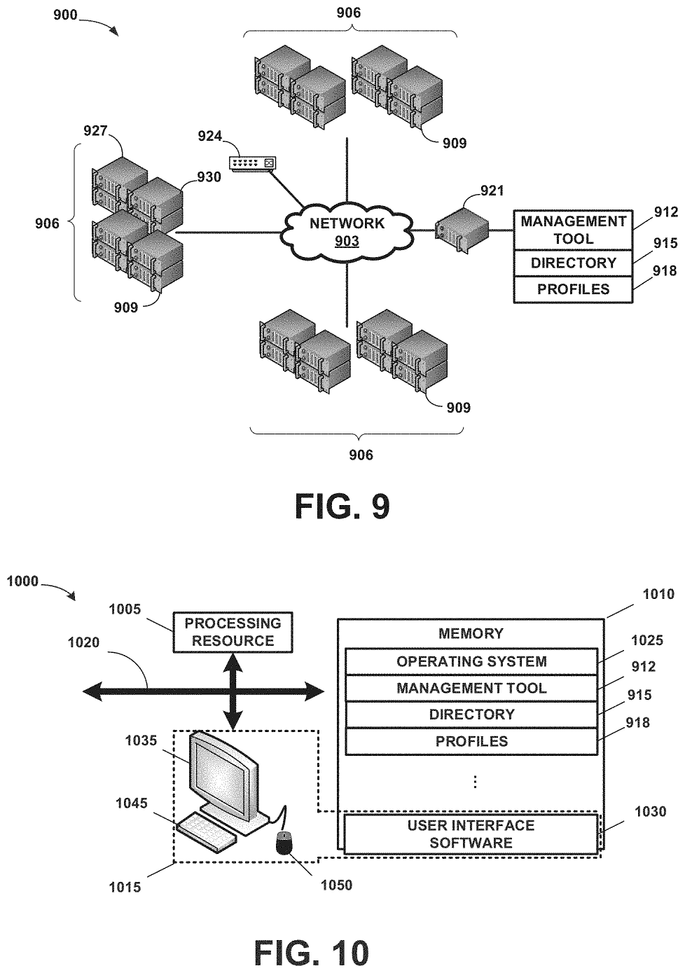

Referring now to FIG. 9, FIG. 9 conceptually illustrates a data center 900 including a computing system in accordance with one or more examples of the subject matter claimed below. The data center 900 includes a networked computing system 903. Those in the art having the benefit of this disclosure will appreciate that the data center 900 will also include supporting components like backup equipment, fire suppression facilities and air conditioning. These details are omitted for the sake of clarity and so as not to obscure that which is claimed below.

A data center network such as the networked computing system 903 typically includes a networking infrastructure including computing resources, e.g., core switches, firewalls, load balancers, routers, and distribution and access switches, servers, etc., along with any hardware and software required to operate the same. For present purposes, the networked computing system 903 will be described as a plurality of dusters 906 of computing resources, each including at least one computing device 909. Note that only one computing device 909 is indicated in each of the dusters 906. The computing system 903 also includes one or more networking switches 924 through which network traffic flows. Again, those in the art will appreciate that any given implementation of the networked computing system 903 will be more detailed. However, these details are omitted for the sake of clarity and so as not to obscure that which is claimed below.

The networked computing system 903 includes a management tool 912. The management tool 912 automates many of the functions in managing the operation and maintenance of the networked computing system 903. For instance, the management tool 912 may provision new computing devices 909 as they are added to the computing system 903. The management tool 912 maintains a directory 915 of the computing devices 909 and profiles 918 for each of the computing devices 909.

One difference between the networked computing system 903 of FIG. 9 and the computing system of FIG. 1 is that the profiles 918 are flex profiles as are discussed above rather than the rigid profiles 118 in FIG. 1. The management tool 912 is therefore able to more robustly and flexibly perform certain tasks within the computing system 903. In the context of local data recovery as discussed relative to FIG. 1-FIG. 7, the computing devices 909 may be implemented using the computing devices 909. Upon the failure of, for instance, of a first computing device 927, the management tool 912 can recover the local data to a second computing device 930 using the method of FIG. 7. Relative to the method of FIG. 8, the method of FIG. 7 may be used to implement (at 820) the transition from the first computing device 927 to the second computing device 930. The second computing device 930 may be identified as discussed above.

However, the use of flex profiles is not limited to the local data recovery technique described above. In such situations, the computing devices 909 may omit some of the features of the computing device 200 shown in FIG. 2. For instance, the independent supply of power from the power source P may be omitted in examples where flex profiles are used for purposes other than local data recovery. Similarly, the independent connection 233 may be omitted.

One use aside from local data recovery is hardware upgrade, or physically replacing hardware with newer or different model with higher performance and/or additional capabilities. In this example, it is desirable that new hardware have capabilities that are superset of previous hardware, meaning that new should be backward compatible. So, in the context of FIG. 9, the first computing device 927 may be replaced by the second computing device 930 using the method of FIG. 8. The “match” in this context will require better performance or additional capabilities in the second computing device 930 relative to the first computing device 927. Preferably, the second computing device 930 will be backward compatible with the first computing device 927.

For instance, in one example, a network adapter may be replaced with a newer model. The new network adapter should support the same protocols such as Internet SCSI (“iSCSI”) as the old network adapter. The new network adapter should accommodate the same or greater number of flex channels and performance characters should be same or higher. Those in the art having the benefit of this disclosure will appreciate that these types of attributes and characteristics will vary depending on what kind of hardware the first computing device 927 and the second computing device 930 are and their functionality within the computing system 903. Furthermore, those in the art with the benefit of this disclosure will readily be able to recognize the attributes and characteristics that are pertinent in this context.

Once a flex profile is applied to an upgraded piece of hardware, a decision has to be made whether to update flex profile device capabilities and performance numbers based on new hardware with the new, better performance characteristics and attributes or to keep it with the same characteristics and attributes. The former choice will limit the number of matches but will result in a more powerful, flexible, and robust performance moving forward. The latter choice will increase the number of matches but will inhibit increasing performance. If flex profile numbers are updated according to new higher performing hardware, it may be called “promoting” the flex profile.

In another example, flex profiles may be used in hardware cloud management. The ability to match hardware based on flex profiles makes it possible to search for equivalent or better hardware from pool of available hardware resources in cloud. It also makes possible reconfiguring the new hardware with same network connections with equivalent matching routes and reprogramming virtual Media Access Control (“MAC”) and World Wide Port Name (“WWPN”) addresses. Still further, it makes possible re-mounting same storage volumes on new hardware and rebooting the servers as if a new operating system (“OS”) and end user feels as if nothing has happened except for minor interruption. This type of transition (or, “migration”) is applicable in a hardware cloud scenario where hardware can by allocated and deallocated without end user knowing the underlying transformations and to scale the infrastructure to support more and more end users. It is also application in a failover scenario when hardware fails but user data volumes are quickly migrated to new hardware and boot from there with minimal down time.

Yet another example in which flex profiles may be used outside of local storage recovery is hardware repair. In this example, when a certain piece of hardware fails, the flex profiles are temporarily migrated to available hardware from a pool of available hardware resources and the user is booted into new hardware to continue to use computing resources. This all occurs while the original hardware is repaired. In order to find hardware from pool of available hardware resources it is not necessary that hardware has to be from exact make and exact model. As long as new hardware can meet or exceed capabilities and performance defined in flex profiles, the new hardware can be utilized.

Once the hardware is repaired, user profiles are migrated back to the recently repaired original hardware, where they are booted back into the OS. Where flex profiles are make and model independent, it is possible replace the hardware from a different model and/or a different make as long as it meets or exceeds the same characteristics, capabilities and performance numbers. This brings an interesting scenario of downgraded hardware in which volumes are temporarily migrated to compatible hardware capabilities but lower in performance while original hardware is repaired, in case no other equivalent performing hardware is available at that time.

Referring again to FIG. 9, the management tool 912—like the management tool 112 in FIG. 1—may be any of a number of management tools known to the art modified to implement the functionality described herein. The management tool 912 may be, for example, a network management system. The management tool 912, among other things, manages the operation and functionality of the computing devices 909.

The management tool 912 may be a suite of software applications that are used to monitor, maintain, and control the software and hardware resources of the networked computing system 903. The management tool 912 may monitor and manage the security, performance, and/or reliability of the computing devices 909. Performance and reliability of the computing devices 909 may include, for instance, discovery, monitoring and management of the computing devices 909 as well as analysis of network performance associated with the computing devices 909 and providing alerts and notifications. The management tool 912 therefore may include one or more applications to implement these and other functionalities.

Returning to FIG. 9, the management tool 912 and local migration artifacts 150 may be hosted on an administrative console such as the administrative console. In this example, the administrative console may include, at least in part, the computing device 921. FIG. 10 illustrates selected portions of a hardware and software architecture of an administrative console 1000 as may be used in one or more examples. In this particular example, the computing device 921 hosts the management tool 912 as well as the directory 915 of the computing devices 909 and the profiles 918. The administrative console 1000 also includes a processing resource 1005, a memory 1010, and a user interface 1015, all communicating over a communication system 1020. The processing resource 1005 and the memory 1010 are in electrical communication over the communication system 1020 as are the processing resource and the peripheral components of the user interface 1015.

The processing resource 1005 may be a processor, a processing chipset, or a group of processors depending upon the implementation of the administrative console 1000. The memory 1010 may include some combination of read-only memory (“ROM”) and random-access memory (“RAM”) implemented using, for instance, magnetic or optical memory resources such as magnetic disks and optical disks. Portions of the memory 1010 may be removable. The communication system 1020 may be any suitable implementation known to the art. In this example, the administrative console 1000 is a stand-alone computing apparatus. Accordingly, the processing resource 1005, the memory 1010 and user interface 1015 are all local to the administrative console 1000 in this example. The communication system 1020 is therefore a bus system and may be implemented using any suitable bus protocol.

The memory 1010 is encoded with an operating system 1025 and user interface software 1030. The user interface software (“UIS”) 1030, in conjunction with a display 1035, implements the user interface 1015. The user interface 1015 includes a dashboard (not separately shown) displayed on a display 1035. The user interface 1015 may also include other peripheral I/O devices such as a keypad or keyboard 1045 and a mouse 1050. In some examples, the screen of the display 1035 may be a touchscreen so that the peripheral I/O devices may be omitted.

Note that in FIG. 10 the user interface software 1030 is shown separately from the management tool 912. As mentioned above, in some embodiments the user interface software 1030 may be integrated into and be a part of the management tool 912. Similarly, the directory 915 and the profiles 918 are shown separately from the management tool 912 but may, in some examples, be considered a constituent part of the management tool 912. Still further, as discussed above, the management tool 912 may comprise a suite of applications or other software components. These software components need not all be located on the same computing apparatus and may, in some examples, be distributed across the networked computing system 903. Similarly, the directory 915 and the profiles 918 may also by distributed across the networked computing system 903 rather than stored collectively on a single computing apparatus. Furthermore, in some examples, the functionality described above that may leverage the profiles 918 may be implemented by a separate software component invoked or called by the management tool 912 or invoked or called by an administrator through the management tool 912.

The processing resource 1005 runs under the control of the operating system 1025, which may be practically any operating system. The management tool 912 is invoked by a user through the dashboard, the operating system 1025 upon power up, reset, or both, or through some other mechanism depending on the implementation of the operating system 1025. The management tool 912, when invoked, may perform the functionality discussed above.

This concludes the detailed description. The particular examples disclosed above are illustrative only, as examples described herein may be modified and practiced in different but equivalent manners apparent to those skilled in the art having the benefit of the teachings herein. Furthermore, no limitations are intended to the details of construction or design herein shown, other than as described in the claims below. It is therefore evident that the particular examples disclosed above may be altered or modified and all such variations are considered within the scope and spirit of the appended claims. Accordingly, the protection sought herein is as set forth in the claims below.

What is claimed is:

1. A method for use in a networked computing system, comprising:
identifying a failure of a first computing device from a management tool, the first computing device including a first network adapter and a first local storage; and
directing, from a management tool, the first network adapter to:
access a plurality of data stored on the first local storage over an independent connection between the first network adapter and the first local storage; and
transmit the data to a second computing device, the second computing device including a second network adapter and a second local storage.

2. The method of claim 1, wherein storing the received data includes storing the received data over an independent connection between the second network adapter and the second local storage.

3. The method of claim 1, wherein the directing and transmitting are performed using an Ethernet protocol.

4. The method of claim 1, wherein at least one of the accessing the data from the first local storage and storing the received data in the second local storage is performed using Small Computer System interface (“SCSI”) protocol, a Serial Attached SCSI (“SAS”) protocol, or a Serial Advanced Technology Attachment (“SATA”) protocol.

5. The method of claim 1, wherein the accessing the data from the first local storage and storing the received data in the second local storage are performed using different protocols.

6. The method of claim 1, wherein the accessing the data stored on the first local storage over the independent connection includes accessing the data through an independent network adapter connector, an independent cable, and an independent local storage connector.

7. The method of claim 1, further comprising:
receiving the transmitted data at the second network adapter; and
storing, by the second network adapter, the received data in the second local storage.

8. A computing device, comprising:
a local storage; and
a network adapter programmed to:
access first data from the local storage responsive to an external direction identifying a detected failure in the computing device; and
transmit the first data to another location; and
an independent connection over which the network adapter accesses the first data from the local storage responsive to the external direction.

9. The computing device of claim 8, wherein the independent connection employs a Small Computer System Interface (“SCSI”) protocol, a Serial Attached SCSI (“SAS”) protocol, or a Serial Advanced Technology Attachment (“SATA”) protocol.

10. The computing device of claim 8, wherein the local storage comprises a plurality of hard disk drives, a plurality of solid-state drive, or a combination of both hard disk drives and solid-state drives.

11. The computing device of claim 8, wherein the network adapter is further programmed to:
receive second data over a network connection from a second network adapter; and
store the second data in the local storage.

12. The computing device of claim 8, wherein the network adapter accesses the first data using Small Computer System Interface (“SCSI”) protocol, a Serial Attached SCSI (“SAS”) protocol, or a Serial Advanced Technology Attachment (“SATA”) protocol.

13. The computing device of claim 8, wherein the independent connection includes:
an independent network adapter connector;
an independent local storage connector; and
an independent cable connected between the independent network adapter connector and the independent local storage connector.

14. The computing device of claim 8, wherein the independent connection includes:
an independent network adapter connector;
a local storage connector;
and a split cable connected between the independent network adapter connector and the local storage connector.

15. A networked computing system, comprising:
a network connection;
a first computing device, including:
a first local storage; and
a first network adapter to which the first local storage is indirectly electronically connected for routine operations and independently connected for failure recovery, the first network adapter programmed to:
access data from the first local storage over the independent connection responsive to an external direction of a detected failure in the computing device; and
transmit the retrieved data to another location over the network connection; and
a second computing device, including:
a second local storage; and
a second network adapter programmed to:
receive the data transmitted by the first network adapter over the network connection; and
provide the received data for storage in the second local storage.

16. The networked computing system of claim 15, wherein the first local storage or the second local storage employs a Small Computer System Interface (“SCSI”) protocol, a Serial Attached SCSI (“SAS”) protocol, or a Serial Advanced Technology Attachment (“SATA”) protocol.

17. The networked computing system of claim 15, wherein the local storage comprises a plurality of hard disk drives, a plurality of solid-state drives, or a combination of hard disk drives and solid-state drives.

18. The networked computing system of claim 15, wherein the second network adapter is further programmed to respond to failure conditions in the second computing device, the response including:
accessing data from the second local storage responsive to an external direction associated with the failure conditions; and
transmitting the retrieved data to another location.

19. The networked computing system of claim 15, wherein the first network adapter is further programmed to:
receive data over the network connection from the second network adapter; and
store the received data in the first local storage.

20. The networked computing system of claim 15, wherein the network connection implements an Ethernet protocol.
